(19) United States
(12) Patent Application Publication
(10) Pub. No.: US 2026/0186957 A1
(43) Pub. Date: Jul. 2, 2026

(54) SELECTIVELY ENABLING NON-VOLATILE MEMORY (NVM) DIES IN CACHE ON COMPUTE DEVICE

(71) Applicant: Micron Technology, Inc., Boise, ID (US)

(72) Inventors: Xiangyu Tang, San Jose, CA (US); Jeffrey S. McNeil, Boise, ID (US); Eric N. Lee, San Jose, CA (US); Akira Goda, Tokyo (JP); Suresh Rajgopal, San Diego, CA (US); Sundararajan Sankaranarayanan, Fremont, CA (US)

(21) Appl. No.: 19/435,395

(22) Filed: Dec. 29, 2025

Related U.S. Application Data
(60) Provisional application No. 63/740,399, filed on Dec. 31, 2024.
(60) Provisional application No. 63/740,397, filed on Dec. 31, 2024.
(60) Provisional application No. 63/768,056, filed on Mar. 6, 2025.

(51) Int. Cl. G06F 12/02; G06N 20/00

(52) U.S. Cl. CPC G06F 12/0238; G06N 20/00

(57) ABSTRACT

A compute device includes a compute die, a on-chip cache with one or more volatile memory dies and one or more non-volatile memory dies, and a memory controller all disposed on the package substrate. The controller determines a first memory size requirement of one or more first operations executed by the compute die, determines that the first memory size requirement satisfies a threshold criterion, and responsive to determining that the first memory size requirement satisfies the threshold criterion, disables the one or more non-volatile memory dies in the on-chip cache.

### RELATED APPLICATIONS

This application claims the benefit of U.S. Provisional Ser. No. 63/740,397, filed Dec. 31, 2024, U.S. Provisional Ser. No. 63/740,399, filed Dec. 31, 2024, and U.S. Provisional Ser. No. 63/768,056, filed Mar. 6, 2025, the entire contents of each of which are hereby incorporated by reference herein.

### TECHNICAL FIELD

Implementations of the disclosure relate generally to compute devices, and more specifically, relate to address selectively enabling non-volatile memory (NVM) dies in cache on a compute device.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various implementations of the disclosure.

FIG. 1 is an example system employing a compute device having a hybrid on-chip cache (e.g., with combined volatile memory (VM) and NVM dies) on a processing die according to some embodiments.

FIG. 2 is a flow chart of an example method for selectively enabling non-volatile memory (NVM) dies in cache on a compute device according to some embodiments.

FIGS. 3A-3B show example high-level component diagrams of hybrid NVM/HBM devices implemented in accordance with aspects of the present disclosure.

FIG. 4 schematically illustrates example logical and physical address spaces of the hybrid NVM/HBM devices implemented in accordance with aspects of the present disclosure.

FIG. 5 illustrates an example computing system that includes a memory sub-system implemented in accordance with some implementations of the present disclosure.

FIG. 6 is a block diagram illustrating a system for performing AI model inference operations using memory devices and/or host systems implemented in accordance with aspects of the present disclosure.

FIG. 7 is a block diagram of an example computer system in which implementations of the present disclosure may operate.

### DETAILED DESCRIPTION

Aspects of the present disclosure are directed to selectively enabling non-volatile memory (NVM) cache on a processing die of a compute device, which can be designed on a common substrate package. A memory sub-system can include one or more storage devices, memory modules, and/or hybrid storage devices and memory modules. Examples of storage devices and memory modules are described below. In general, a host system can utilize a memory sub-system that includes one or more components, such as memory devices that store data. The host system can provide data to be stored at the memory sub-system and can request data to be retrieved from the memory sub-system.

A memory sub-system may utilize one or more memory devices, including any combination of the different types of non-volatile memory devices and/or volatile memory devices, to store the data provided by the host system. In some implementations, non-volatile memory devices may be provided by negative-and (NAND) type flash memory devices. A non-volatile memory device is a package of one or more dies. Each die (“logical unit”) may include one or more planes. For some types of non-volatile memory devices (e.g., NAND devices), each plane may include a set of physical blocks. Each block may in turn include a set of pages. Each page includes a set of memory cells. A memory cell is an electronic circuit that stores one or more bits of information.

A memory device may include multiple memory cells arranged in a two-dimensional grid. The memory cells can be formed onto a silicon wafer in an array of columns and rows. A memory cell includes a capacitor that holds an electric charge and a transistor that acts as a switch controlling access to the capacitor. Accordingly, the memory cell may be programmed (written to) by applying a certain voltage, which results in an electric charge being held by the capacitor. The memory cells are joined by wordlines, which are conducting lines electrically connected to the control gates of the memory cells, and bitlines, which are conducting lines electrically connected to the drain electrodes of the memory cells.

Depending on the cell type, each memory cell may store one or more bits of information and has various logic states that correlate to the number of bits being stored. The logic states may be represented by binary values, such as “0” and “1”, or combinations of such values. A memory cell may be programmed (written to) by applying a certain voltage to the memory cell, which results in an electric charge being held by the memory cell, thus allowing modulation of the voltage distributions produced by the memory cell. A set of memory cells referred to as a memory page may be programmed together in a single operation, e.g., by selecting consecutive bitlines.

Precisely controlling the amount of the electric charge stored by the memory cell allows establishing multiple logical levels, thus effectively allowing a single memory cell to store multiple bits of information. A read operation may be performed by comparing the measured threshold voltages (Vt) exhibited by the memory cell to one or more reference voltage levels in order to distinguish between two logical levels for single-level cell (SLCs) and between multiple logical levels for multi-level cells. Each logical level may be translated into a corresponding binary representation of the content of the memory cell.

Memory access operations (e.g., a read operation, a programming (write) operation, an erase operation, etc.) may be executed with respect to sets of the memory cells, e.g., in response to receiving memory access commands from the host. A memory access operation may specify the requested memory access operation (e.g., write, erase, read, etc.) and a logical address, which the memory sub-system would translate to a physical address identifying a set of memory cells (e.g., a block).

In some implementations, memory sub-systems can be used to store data used to train machine learning (ML) and artificial intelligence (AI) frameworks, as well as data on which the ML/AI framework can be executed. An ML/AI framework can include a model, which is a representation of a neural network designed to produce one or more outputs responsive to one or more inputs. In such frameworks, the amount of data used to train the ML models can be extremely large and a training process cycle can be executed multiple times (e.g., multiple “epochs”). For example, an ML framework used to classify an image as being a particular type of image (e.g., an image of a person, an animal, a type of animal, etc.) can utilize a large data set of stored images that are repeatedly processed in multiple epoch cycles to train the model. Similarly, data sets used for testing and/or inference stages of a ML/AI workflow can include very large amounts of data. For example, the inference stage utilizes the trained model, which is very large and requires significant storage, to make predictions or decisions on new input data. This process can include processing the input data, feeding it into the model, and post-processing the output of the model if necessary.

In order to process the large amounts of data, many host systems executing ML/AI frameworks include multiple processing units or compute devices (e.g., graphics processing units (GPUs) and/or central processing units (CPU)) which can process multiple threads/streams in parallel. During a training phase, the processing units may perform forward propagation of inputs, followed by backward propagation (adjusting weights to minimize error), followed by an update of the weights in memory, and ultimately the generation of outputs. In general, training an ML/AI model involves storing and frequently accessing or modifying large amounts of data, including model states, weights, parameters, etc. During an inference phase, these processing units utilize relatively small chunks of data (e.g., tens or hundreds of bytes) from a significantly larger corpus of data (e.g., many gigabytes or terabytes) stored at a memory sub-system. For example, the inference phase may involve walking through multiple graph nodes in order to determine the value of a vertex element and identify its connections.

In some implementations, the input data can be loaded from the memory sub-system to a local host memory co-located with the processing units executing the ML/AI framework. This host memory can be implemented using high bandwidth memory (HBM) devices that offer extremely high (i.e., fast) performance, but have relatively low storage capacities.

In some implementations, multiple processing units or compute devices (GPUs and/or CPUs) can be connected to a shared memory pool, such that each processing unit can have its own local memory and can also access, over a high-speed interconnect, the memory that is local to other processing units. However, the local memory accesses would exhibit much lower latency as compared to the remote memory accesses.

Thus, the memory capacity is one of the biggest challenges faced by enterprise deployment of AI/ML models. Various solutions involve increasing the number of dies stacked in HBM packages accessible by a processing unit or compute device (e.g., a GPU) and implementing various non-uniform memory access (NUMA) schemes in which a processing unit, in addition to its local memory, may also access a local memory of another processing unit. However, these and other solutions fail to adequately satisfy the growing memory capacity requirements while delivering the requisite memory access bandwidth and latency, not to mention containing the costs.

Aspects of the present disclosure address the above and other deficiencies by integrating non-volatile memory (NVM) dies (e.g., NAND dies) with volatile memory (VM) dies (e.g., HBM dies) as on-chip cache within a single hybrid compute device (e.g., an integrated circuit (IC) on a common package substrate of a GPU or CPU). Thus, in some embodiments, the hybrid compute device is or includes a processing unit such as a GPU or CPU, thus affording increased memory capacity on the same package as a compute die, reducing the need for off-package data movement operations between the memory dies because the VM/NVM dies are locally accessible by the compute die. In illustrative embodiments, the hybrid compute device includes, in addition to the compute die, one or more one NVM dies, one or more HBM dies, and a logic die on which a local memory controller can reside. The local memory controller can perform the address translation and other local memory management tasks, which will be discussed in more detail below. In some embodiments, the hybrid compute device includes one or more compute dies on which one or more processing units (GPUs and/or CPUs) reside.

The addition of non-volatile memory dies (e.g., NAND dies) to the on-chip cache can significantly increase the local storage capacity of the hybrid compute device. In many circumstances this enables the training and deployment of ML/AI models to be performed more effectively, as the large data access patterns and storage requirements that often exist in AI/ML (or similar) architectures can be accommodated. This can result in improved performance and decreased training times for certain ML/AI models. The non-volatile memory dies do have lower access bandwidth than the volatile memory dies (e.g., HBM dies), and thus, the on-chip cache implemented using the VM/NVM dies with have a bandwidth that is slower than the conventional pure HBM memory. Accordingly, even that the capacity is increased, there may be certain circumstances (e.g., when the memory size requirements associated with training a given ML/AI model are relatively low) when the use of VM/NVM dies for the on-chip cache actually hurts performance in the hybrid compute device, such as by increasing the overall training time of the ML/AI model.

Thus, in some embodiments, the local memory controller in the hybrid compute device can selectively enable and disable the non-volatile memory dies in the on-chip cache. In some embodiments, both the volatile memory dies and the non-volatile memory dies in the on-chip cache are enabled by default and available for use. The local memory controller can monitor the memory size requirements of a current ML/AI model and the associated operations being or to be performed, and if those requirements satisfy a threshold criterion, the local memory controller can disable the non-volatile memory dies in the on-chip cache. This leaves the volatile memory dies enabled and available to store data associated with the current operations (e.g., training the ML/AI model). The status of the non-volatile memory dies can be dynamically updated, such that if the memory size requirements in the hybrid compute device change (i.e., no longer satisfy the threshold criterion), the local memory controller can reenable the non-volatile memory dies to make them available for use again (e.g., training a different larger ML/AI model).

The advantages of the approaches described herein include, but are not limited to, the improved performance of memory devices and subsystems, which may be particularly beneficial when used with ML/AI frameworks, and will be described in more detail herein below. The addition of non-volatile memory device to the on-chip cache increases the total memory capacity in the hybrid compute device and allows for more storage without requiring the use of external cache that is only accessible over a slower communication interface (e.g., PCIe). The non-volatile memory also allows the stored data to persist in the event of power loss, processor crashes, or other error events. Allowing the non-volatile memory to be selectively disabled, ensures that performance in the hybrid compute device remains high across a spectrum of memory size requirements. This ensures that the overall training time for ML/AI models with varying memory size requirements remains low and is not negatively impacted by the inclusion of the non-volatile memory dies in the on-chip cache.

In some implementations, one or more hybrid compute devices implemented in accordance with one or more aspects of the present disclosure may be packaged into a specified form factor, e.g., a form factor utilized by non-volatile memory devices, a form factor utilized by storage devices (such as solid state drives (SSDs)), or the like. Using a standard memory form factor would facilitate seamless integration of the device into various computing systems, such as (e.g., Internet-of-Things (IoT) devices, wearable or portable computing devices, automotive computing devices, enterprise compute systems, or enterprise storage systems, etc.).

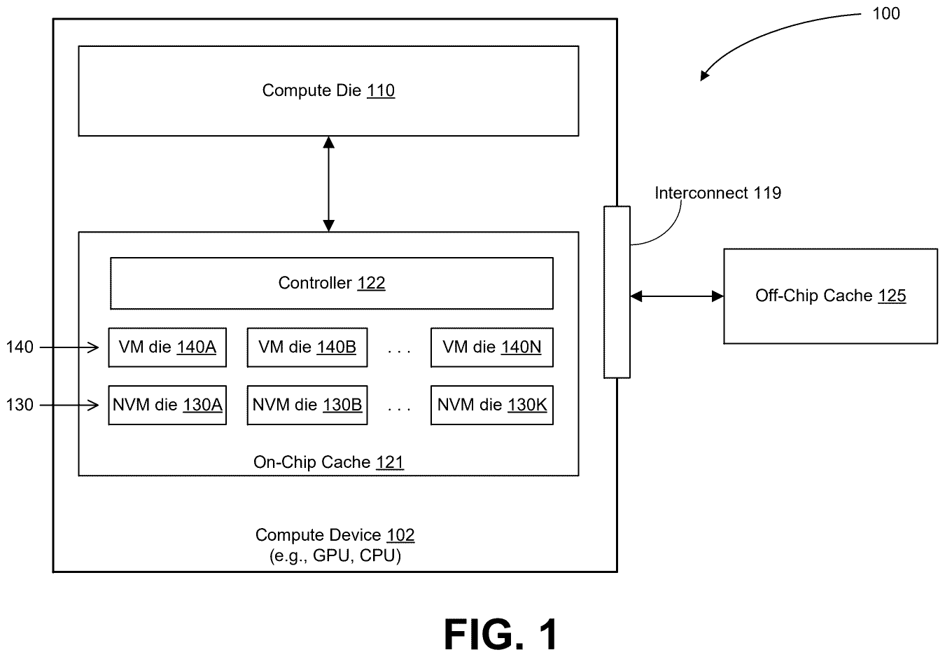

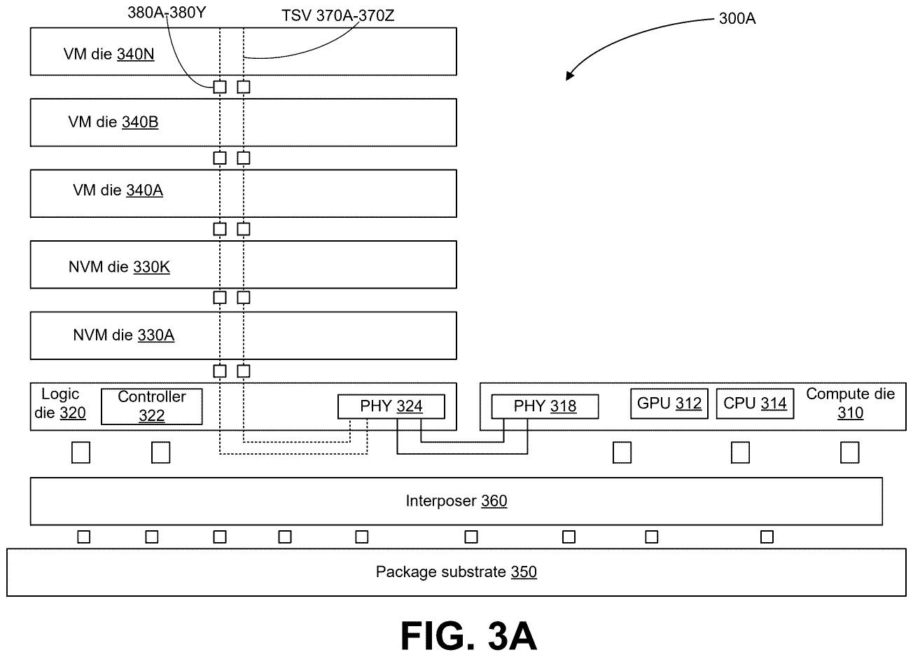

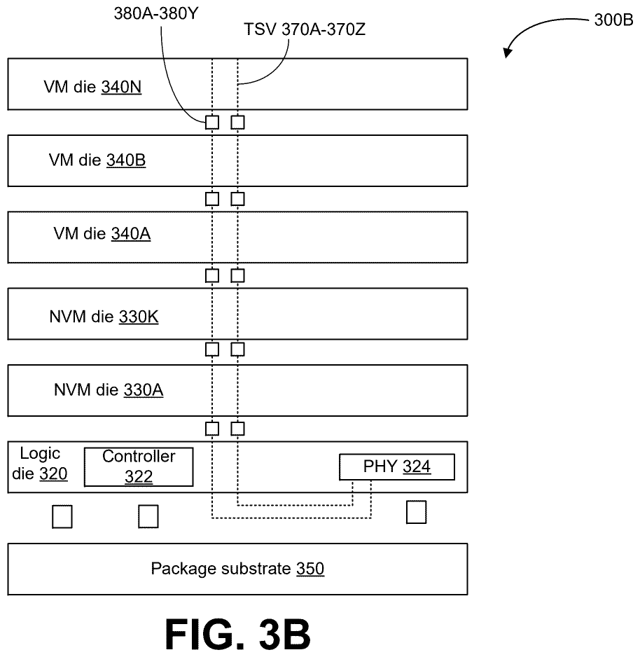

FIG. 1 is an example system 100 employing a compute device 102 having a hybrid on-chip cache 121 (e.g., combined VM and NVM dies) on a processing die according to some embodiments. The compute device 102 can include memory and compute components disposed on a common package substrate (see FIGS. 3A-3B). The system 100 can further include an interconnect 119 disposed on the package substrate and coupled to a off-chip cache 125 that is disposed off of the package substrate. In an embodiment, the interconnect 119 is a Peripheral Component Interconnect Express (PCIe) or other high-speed interface that connects components of a printed circuit board, e.g., like graphics cards, hard drives, and network adapters.

In some embodiments, the compute device 102 includes a compute die 110 disposed on the package substrate and the on-chip cache 121 disposed on the package substrate and coupled to the compute die 110. In embodiments, the on-chip cache 121 includes one or more volatile memory dies (e.g., VM dies 140) and one or more non-volatile memory dies (e.g., NVM dies 130). For example, the VM dies 140 can include a first VM die 140A, a second VM die 140B, through to an Nth VM die 140N, which can be DRAM, but for higher speed modern compute devices, may be HBM dies. Further, the NVM dies 130 can include a first NVM die 130A, a second NVM die 130B, through to a Kth NVM die 130K, which can be, for example, NAND dies or flash-based memory dies.

In some embodiments, the compute device 102 includes a memory controller 122, disposed on the package substrate, and coupled between the compute die 110 and the on-chip cache 121. Thus, the memory controller 122 can be located as part of the on-chip cache 121 or as stand-alone processing logic on a logic die (see FIGS. 3A-3B). In at least some embodiments, the memory controller 122 is configured to make management of the on-chip cache 121 transparent to the compute die 110.

For example, the memory controller 122 can make the combination of the VM dies 140 and the NVM dies 130 appear as uniform cache and manage address translations, compensation for delay between access speeds of VM dies compared to NVM dies, and other media management associated with the on-chip cache 121. The memory controller 122 can balance data-storing workloads across the VM dies 140 and the NVM dies 130, manage the NVM dies 130 for garbage collection and data integrity, and selectively enable and disable the NVM dies 130 in the on-chip cache 121. As will be described in more detail below, the memory controller 122 can monitor the memory size requirements of a current ML/AI model being executed on compute die 110, and the associated operations being or to be performed, and if those requirements satisfy a threshold criterion, the memory controller 122 can disable the non-volatile memory dies 120 in the on-chip cache 121. This leaves the volatile memory dies 140 enabled and available to store data associated with the current operations (e.g., training the ML/AI model). The status of the non-volatile memory dies 130 can be dynamically updated, such that if the memory size requirements in the compute device 102 change (i.e., no longer satisfy the threshold criterion), the memory controller 122 can reenable the non-volatile memory dies 130 to make them available for use again (e.g., training a different larger ML/AI model).

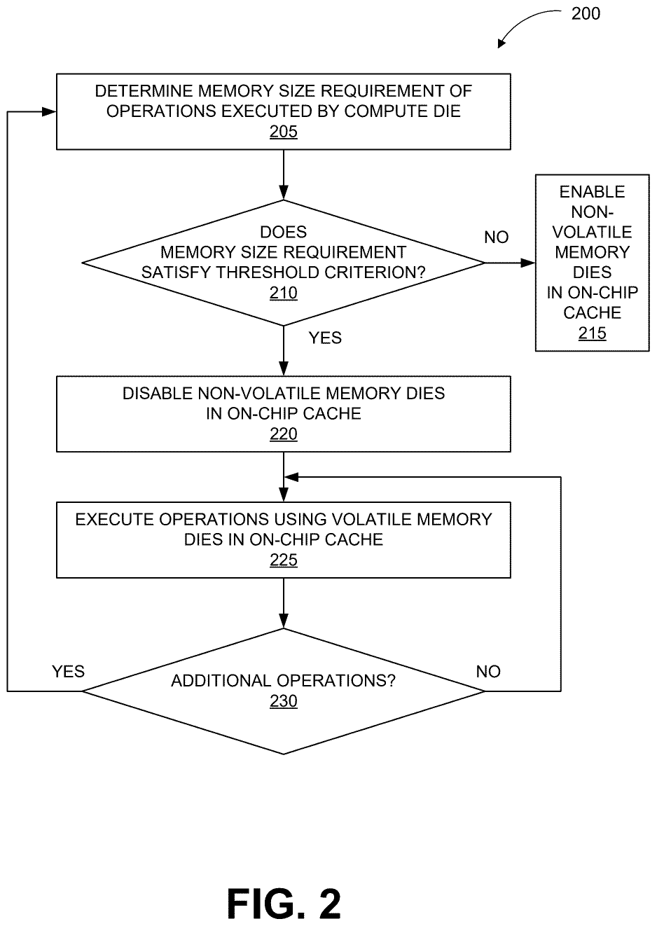

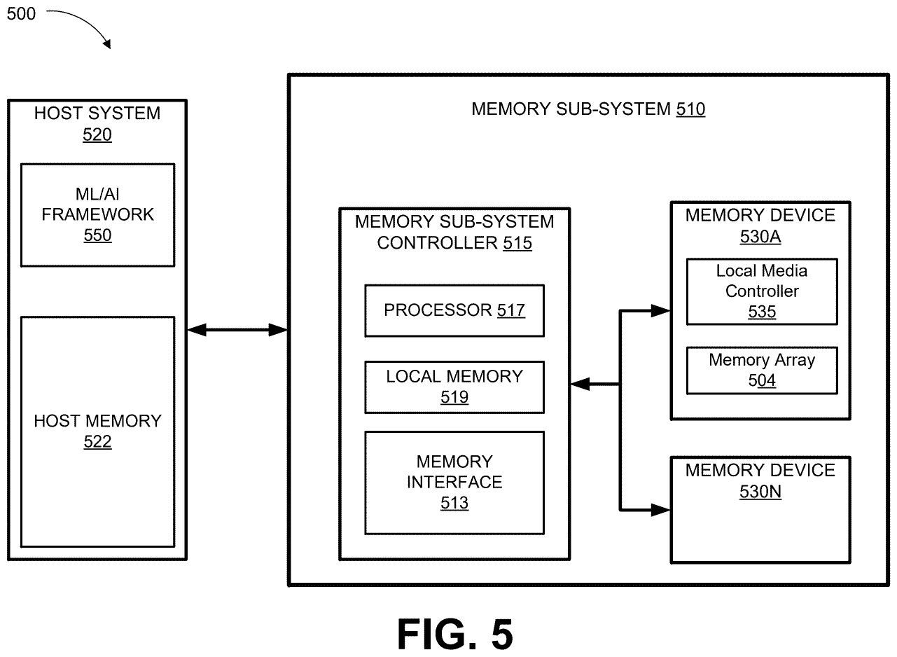

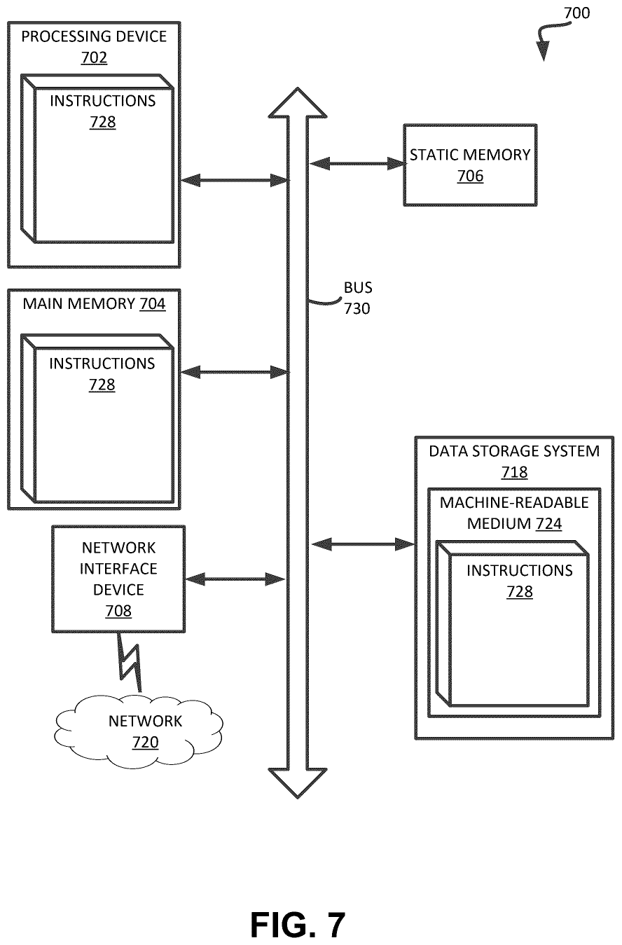

FIG. 2 is a flow chart of an example method for selectively enabling non-volatile memory (NVM) dies in cache on a compute device according to some embodiments The method 200 may be performed by processing logic that may include hardware (e.g., processing device, circuitry, dedicated logic, programmable logic, microcode, hardware of a device, integrated circuit, etc.), software (e.g., instructions run or executed on a processing device), or a combination thereof. In an illustrative example, the method 200 is performed by the controller 122 in the on-chip cache 121 of compute device 102, as shown in FIG. 1. In another illustrative example, the method 200 is performed by the memory sub-system controller 515 of FIG. 5. In another illustrative example, the method 200 is performed by the processing device 702 of FIG. 7. Although shown in a particular sequence or order, unless otherwise specified, the order of the operations may be modified. Thus, the illustrated implementations should be understood only as examples, and the illustrated operations may be performed in a different order, while some operations may be performed in parallel. Additionally, one or more operations may be omitted in some implementations. Thus, not all illustrated operations are required in every implementation, and other process flows are possible.

At operation 205, the processing logic (e.g., controller 122) determines a memory size requirement of one or more operations executed by a compute die, such as compute die 110 of compute device 102. As described above, compute device 102 can be a GPU, for example, and compute die 110 can include one or more processing units configured to execute various operations. In one embodiment, the one or more operations comprise training at least one of a machine learning (ML) model or artificial intelligence (AI) model. In other embodiments, the one or more operations comprise executing (e.g., generating an inference using) at least one of the ML model or the AI model. As further described above, the compute device can also include an on-chip cache 121 that includes one or more volatile memory dies 140 and one or more non-volatile memory dies 130. In one embodiment, the one or more volatile memory dies 140 comprise high-bandwidth memory (HBM) dies and the one or more non-volatile memory dies comprise negative-and (NAND) type flash memory dies.

The various operations executed by the compute die 110 can have differing memory size requirements, and specifically for the on-chip cache 121. For example, training certain ML/AI models may require less memory capacity (e.g., to store the model itself, an optimizer, activations functions, model weights, etc.), while training other ML/AI models may require significantly more memory capacity in the on-chip cache 121. In one embodiment, in order to determine the memory size requirement of the one or more operations executed by the compute die 110, controller 122 receives an indication of the memory size requirement from the compute die. For example, during initialization operations, or at some other periodic interval, the controller 122 can notify the compute die 110 (or a separate host system, such as host system 520 of FIG. 5) of the size, capacity, and read/write bandwidth of the non-volatile memory dies 130. During execution of the operations, the compute die 110 (or host system 520) can determine when the operations (e.g., the training of the ML/AI model) will require additional memory capacity and can communicate a request (e.g., a hint) to the controller 122 that the non-volatile memory dies 130 should be enabled. The controller 122 can disable the non-volatile memory dies 130 in the absence of such a request in order to improve performance.

In another embodiment, in order to determine the memory size requirement of the one or more operations executed by the compute die 110, controller 122 monitors one or more operational parameters of the non-volatile memory dies 130 to determine a bandwidth associated with the non-volatile memory dies 130 and determines a saturation level of the volatile memory dies 140. For example, the controller 122 can periodically measure the physical/logical saturation of the non-volatile memory dies 130, the temperature of the non-volatile memory dies 130, the health/reliability of the non-volatile memory dies 130, the number of non-volatile memory dies 130, the SLC/MLC/TLC/QLC configuration of the non-volatile memory dies 130, and/or other operational parameters. The controller 122 can further periodically measure the logical/physical saturation of the volatile memory dies 140. Together, this information can be used to determine the memory size requirement of the one or more operations.

At operation 210, the processing logic determines whether the memory size requirement satisfies a threshold criterion. In one embodiment, in order to determine whether the memory size requirement satisfies the threshold criterion, the controller 122 can determine whether the memory size requirement is less than a predefined threshold amount. Thus, if the memory size requirement is less than the predefined threshold amount, the controller 122 can determine that the threshold criterion in satisfied. Conversely, if the memory size requirement is greater than or equal to the predefined threshold amount, the controller 122 can determine that the threshold criterion is not satisfied. In one embodiment, the predefined threshold amount is based on the bandwidth associated with the one or more non-volatile memory dies 130. Given than the non-volatile memory dies 130 have a lower bandwidth than the volatile memory dies 140, the inclusion of the non-volatile memory dies 130 in the on-chip cache 121 will reduce the overall bandwidth of the on-chip cache 121, in an amount proportional to the size of the non-volatile memory dies 130 relative to the volatile memory dies 140. Accordingly, with more non-volatile memory dies 130, and thus a lower bandwidth, the predefined threshold amount is also lower. Conversely, with fewer non-volatile memory dies, and thus a higher bandwidth, the predefined threshold amount is higher.

Responsive to determining that the memory size requirement does not satisfy the threshold criterion, at operation 215, the processing logic enables the one or more non-volatile memory dies 130 in the on-chip cache 121. Since the memory size requirement is relatively large (i.e., greater than or equal to the predefined threshold amount), controller 122 can enable the non-volatile memory dies 130 such that they are available for storing data associated with the execution of the operations by the compute die 110 (e.g., the training of the ML/AI model). Enabling the non-volatile memory dies 130 increased the memory capacity of the on-chip cache 121 which can improve operations in the compute device, such as by lowering the overall training time for the ML/AI model with relatively large memory size requirements.

Responsive to determining that the memory size requirement satisfies the threshold criterion, at operation 220, the processing logic disables the one or more non-volatile memory dies 130 in the on-chip cache 121. Since the memory size requirement is relatively small (i.e., less than the predefined threshold amount), controller 122 can disable the non-volatile memory dies 130 such that they are not available for storing data associated with the execution of the operations by the compute die 110 (e.g., the training of the ML/AI model). In some embodiment, only a portion of the non-volatile memory dies 130 are disabled. For example, if there are four non-volatile memory dies 130 in the on-chip cache 121, depending on the memory size requirements, one, two, or three non-volatile memory dies 130 may be disabled. In one embodiment, the controller 122 can disable one or more of the non-volatile memory dies 130 by turning off the power supply to those non-volatile memory dies 130 to prevent data from being stored thereon.

At operation 225, the processing logic executes the operations of the compute die 110 using the volatile memory dies 140 in the on-chip cache 121. When the non-volatile memory dies 130 are disabled, the data associated with execution of the operations (e.g., the training of the ML/AI model) can be stored in the volatile memory dies 140 in the on-chip cache 121.

At operation 230, the processing logic determines if there are additional operations to be executed by the compute die 110 (i.e., operations separate from those analyzed previously). If so, processing can return to operation 205, where controller 122 can determine a second memory size requirement of one or more second operations executed by the compute die 110, determine, at operation 210, whether the second memory size requirement satisfies the threshold criterion, and responsive to determining that the second memory size requirement does not satisfy the threshold criterion, at operation 215, re-enabling the one or more non-volatile memory dies 130 in the on-chip cache 121. This permits the non-volatile memory dies 130 to be selectively and dynamically enabled or disabled depending on the memory size requirements of the operations currently being executed by the compute die 110.

FIG. 3A shows an example high-level component diagram of a hybrid NVM/HBM device implemented in accordance with aspects of the present disclosure. As schematically illustrated by FIG. 3A, the hybrid memory and compute device 300A may be implemented as an integrated circuit (IC) that includes a compute die 310, a logic die 320, one or more NVM dies 330A-330K, and one or more volatile memory (VM) dies 340A-340N, all the dies being disposed on a common package substrate 350.

Disposed on the compute die 310 are one or more processing units (e.g., one or more GPUs 312 and/or one or more CPUs 314) and their respective auxiliary circuitry, including local memory, input/output (I/O) interfaces, etc., which are omitted from FIG. 3A for clarity and conciseness. While a single compute die 310 is shown in FIG. 3A for clarity and conciseness, in various other implementations, device 300A may include two or more compute dies 310.

In some implementations, an NVM die 330 may be represented by a NAND die. In some implementations, one or more NVM dies 330 may be single-level cell (SLC) NAND dies, which exhibit better endurance and lower access latency as compared, e.g., to multiple-level cell (MLC), triple-level cell (TLC), or quad-level cell (QLC) dies. In some implementations, a VM die 340 may be represented by an HBM dynamic random access memory (DRAM) die.

While a single logic die 320 is shown in FIG. 3A for clarity and conciseness, in various other implementations, device 300A may include two or more logic dies 320.

The stacked VM dies 340, NVM dies 330, and the logic die 320 may be interconnected by through-silicon vias (TSVs) 370A-370Z and microbumps 380A-380Y. A TSV is a high-performance interconnect technique that utilizes a vertical electrical connection (via) that passes through a silicon wafer or die. “Microbumps” are small raised spheres which are made of a conductive material and connect a die with another die or a substrate, thus serving as conduits delivering electrical signals from one part of a chip to another.

The components disposed on the compute die 310 may communicate with the components disposed on the logic die 320, components disposed on the NVM dies 330A-330K, and/or components disposed on the VM dies 340A-340N via respective physical interfaces (PHYs) 318, 324 interconnected by the interposer 360. An interposer is an electrical interface routing electrical signals between one socket or connection and another socket or connection. Thus, the memory access requests issued by the processing units residing on the compute die 310 may be transmitted via the interposer 360 to the logic die 320.

Disposed on the logic die 320 is the controller 322 managing the NVM dies 330 and/or the VM dies 340. In some implementations, the controller 322 may implement a common logical address space for the VM dies 340A-340N and the NVM dies 330A-330K. Accordingly, the controller 322 may perform logical-to-physical (L2P) address translation based on the common logical address space.

In some implementations, no address translation (other than offsetting by a predefined value) may be required for the logical addresses that are below the upper limit of the user-addressable capacity of the VM dies 340A-340N. In other words, the logical addresses within the user-addressable capacity of the VM dies 340A-340N will directly (e.g., with an optional offset) reference respective memory locations on the VM dies 340A-340N, while the logical addresses exceeding the upper limit of the user-addressable capacity of the VM dies 340A-340N:

if LBA <= NVM Capacity then PA_{VM} = LBA + Offset
else PA_{NVM} = L2P[LBA]

where LBA is the logical block address,
NVM Capacity is he user-addressable capacity of the VM dies 340A-340N,
PA_{VM} is the physical address of a transfer unit (TU) residing on the VM dies 340A-340N,
Offset is the optional offset to be applied to the logical addresses,
PA_{NVM} is the physical address of a TU residing on the VM dies 330A-330K,
L2P[ . . . ] is the logical-to-physical (L2P) address translation table, and
L2P[LBA] is the physical address corresponding to the specified LBA.

In an illustrative example, the total user-addressable capacity of the VM dies 340A-340N may be 40 GB, while the total user-addressable capacity of the NVM dies 330A-330K may be 128 GB. Thus, the memory access requests initiated by the compute die 310 with respect to transfer units (TUs) (such as memory pages, blocks, etc.) referenced by logical addresses below the upper limit of the user-addressable capacity of the VM dies 340A-340N may be satisfied directly via the physical interfaces 318 and 324 accessing the VM dies 340A-340N.

Conversely, memory access requests initiated by the compute die 310 with respect to TUs referenced by the logical addresses exceeding the upper limit of the user-addressable capacity of the VM dies 340A-340N may be sent to the controller 322, which may translate these logical addresses to corresponding physical addresses of TUs residing on the NVM dies 330A-330K. The address translation may be facilitated by a logical-to-physical (L2P) table, which may be indexed by the logical addresses so that each entry of the table would store a physical address corresponding to the logical address identifying the entry:

$${PA}_{NVM} = L 2 P / [ LBA ] .$$

FIG. 3B shows another example high-level component diagram of a hybrid NVM/HBM device 300B implemented in accordance with aspects of the present disclosure. As schematically illustrated by FIG. 3B, the hybrid memory device 300B may be implemented as an integrated circuit (IC) that includes a logic die 320, one or more NVM dies 330A-330K, and one or more volatile memory (VM) dies 340A-340N, all the dies being disposed on a common package substrate 350. While a single logic die 320 is shown in FIG. 3B for clarity and conciseness, in various other implementations, device 300B may include two or more logic dies 320. The stacked VM dies 340, NVM dies 330, and the logic die 320 may be interconnected by through-silicon vias (TSVs) 370A-370Z and microbumps 380A-380Y.

Disposed on the logic die 320 is the controller 322 managing the NVM dies 330 and/or the VM dies 340. In some implementations, the controller 322 may implement a common logical address space for the VM dies 340A-340N and the NVM dies 330A-330K. Accordingly, the controller 322 may perform logical-to-physical (L2P) address translation based on the common logical address space, as described in more detail herein above.

The host system (not shown in FIG. 3B) may communicate with the components disposed on the logic die 320, components disposed on the NVM dies 330A-330K, and/or components disposed on the VM dies 340A-340N via the host interface 324. In some implementations, the host interface 324 may be represented by a logical host interface (e.g., NVMe) operating over a physical host interface (e.g., PCIe, CXL, SATA Express, etc.).

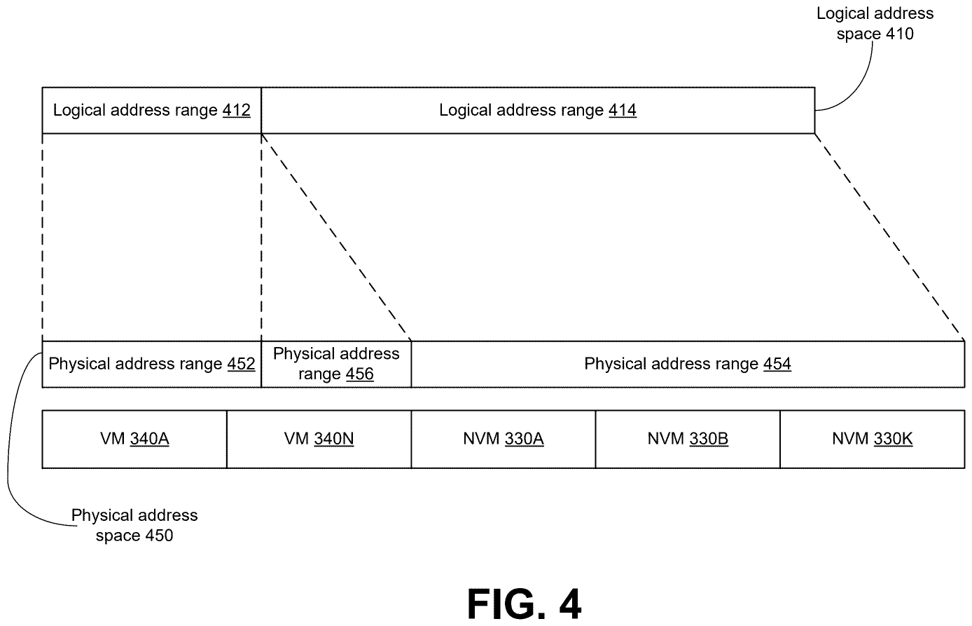

FIG. 4 schematically illustrates the example logical address space 410 and physical address space 450 of the device 300A-310B in accordance with aspects of the present disclosure. As schematically illustrated by FIG. 4, the logical address space 410 includes two logical address ranges 412 and 414.

The logical address range 412, the size of which matches the size of the user-addressable capacity of the VM dies 340A-340N, contains logical addresses that directly (e.g., with an optional offset) reference respective memory locations residing within the VM physical address range 452 corresponding to the user-addressable capacity of the VM dies 340A-340N.

The logical address range 414, residing immediately above the logical address range 412, contains logical addresses that are translatable to corresponding physical addresses identifying TUs that reside within the NVM physical address range 454 on the NVM dies 330A-330K. In some embodiments, the discussion with reference to FIG. 4 is applicable to the VM dies 140 and the NVM dies 130 of FIG. 1, where although both can be treated as on-chip cache, the VM dies 140 is faster-access cache and the NVM dies 130 is slower-access cache, and thus designed to back up the faster-access cache.

In some implementations, one or more physical address sub-ranges within the physical address ranges 452 and/or 454 may be reserved by the controller 322 for performing, e.g., various memory management and/or other system tasks. Accordingly, the size of the physical address range 452 and the size of the corresponding logical address range 412 may be less than the combined capacity of the VM dies 340A-340N. Similarly, the size of the physical address range 454 and the size of the corresponding logical address range 414 may be less than the combined capacity of the NVM dies 330A-330K.

In some implementations, content of the NVM dies 330A-330K may not be directly accessible by the processing units 312, 314 or the compute die 110 (FIG. 1). In an illustrative example, the controller 322 may reserve the capacity of the VM dies 340A-340N (or 140A-140N in FIG. 1) as fast-access cache to store certain portions (e.g., most recently accessed portions or most frequently accessed portions) of the slower-access content of the NVM dies 330A-330K (or 130A-130K of FIG. 1), although both may still be treated as the on-chip cache 121.

In operation, responsive to receiving a memory read request specifying a logical memory address to be read, the memory interface implemented by the logic die 320 may determine whether the logical memory address specified by the memory read request falls within the VM physical address range 452 corresponding to the fast-access capacity of the VM dies 340A-340N.

If the logical memory address specified by the memory read request falls within the VM physical address range 452, the memory interface implemented by the logic die 320 may read, from a volatile memory die 340A-340N, the data item stored in the location identified by the logical memory address. In some embodiments, the data item is returned to the requestor (e.g., a processing unit 312, 314 or the compute die 110) via the memory interface (e.g., the physical interfaces 318, 324).

Conversely, if the logical memory address specified by the memory read request falls outside the VM physical address range 452 and/or 456, the controller 322 may translate the logical address to a corresponding physical address within the physical address range 454 and/or 456. The controller 322 may then read the data stored at the TU (e.g., a block or a page) referenced by the physical address and return the data to the requestor (e.g., a processing unit 312, 314) via the memory interface (e.g., the physical interfaces 318, 324).

The controller 322 may determine whether the contents of the TU identified by the physical address had previously been cached in the VM dies 340A-340N (or 140A-140N of FIG. 1 of the fist-level cache 121). Should a hit occur, the read request may be satisfied from the VM dies. The contents of the identified cache line may be returned to the requestor (e.g., a processing unit 312, 314 or compute die 110) via a volatile memory interface (e.g., including the physical interfaces 318 and/or 324). In case of a miss, the controller 322 may allocate a new cache entry in the VM dies 340A-340N, read the contents of the TU identified by the physical address, store the retrieved data item in the newly allocated cache entry, and return the data item to the requestor processing unit 312, 314 via the volatile memory interface.

With additional reference to FIG. 1, in some embodiments, the on-chip cache 121 may implement the write-through policy. Accordingly, responsive to subsequently receiving a memory write request, the controller 122 or 322 may identify the cache entry whose tag matches the physical address corresponding to the logical address specified by the request. The controller 122 or 322 may store the data item specified by the memory request to the identified cache entry. The controller 122 or 322 may then store the content of the cache entry to the TU identified by the physical address. In various use cases, the compute device 102 or the IC 300 may be employed for both training and inference stages of AI models, such as large language models (LLMs), generative transformer models, etc.

In an illustrative example, the hybrid memory and the compute die 110, or hybrid memory and the compute device 300A, and/or the hybrid memory device 300B may be utilized for training of an artificial intelligence (AI) model. In another illustrative example, the compute device 102 and/or the hybrid memory devices 300A-300B may be utilized for implementing an inference stage of an artificial intelligence (AI) model.

In an illustrative example, training an AI model involves the need of storing and frequently accessing or modifying large amounts of data, including model states, weights, parameters, etc. This need can be effectively addressed by the compute device 102, the hybrid memory and compute device 300A, and/or the hybrid memory device 300B, which significantly increases the size of the local memory co-located with one or more processing units or the compute die 110.

In another illustrative example, performing an inference by an AI model involves handling a very large size of the model context, which requires the memory capacity that may exceed that of currently available solutions. This requirement is effectively met by the compute device 102, the hybrid memory and compute device 300A, and/or the hybrid memory device 300B, which can significantly increase the size of the local memory co-located with one or more processing units or the compute die 110.

FIG. 5 illustrates a high-level component diagram of an example computing system 500 that includes a memory sub-system 510 in accordance with some implementations of the present disclosure. The memory sub-system 510 can include one or more memory devices 530A-530N, which may include one or more volatile memory devices, and/or one or more non-volatile memory devices. In an illustrative example, one or more memory devices 530 may be represented by the compute device 102 or hybrid NVM/HBM devices 300A and/or 300B.

The memory sub-system 510 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 500 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 500 can include a host system 520 that is coupled to one or more memory sub-systems 530. In some implementations, the host system 520 is coupled to different types of memory sub-system 510. FIG. 5 illustrates one example of a host system 520 coupled to one memory sub-system 510. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 520 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 520 uses the memory sub-system 510, for example, to write data to the memory sub-system 510 and read data from the memory sub-system 510.

The host system 520 can be coupled to the memory sub-system 510 via a physical host interface. Examples of physical host interfaces include a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 520 and the memory sub-system 510. The host system 520 can further utilize an NVM Express (NVMe) interface to access the memory components (e.g., the one or more memory device(s) 530) when the memory sub-system 510 is coupled with the host system 520 by the physical host interface (e.g., PCIe or CXL bus). The physical host interface can provide an interface for passing control, address, data, and other signals between the memory sub-system 510 and the host system 520. FIG. 5 illustrates a memory sub-system 510 as an example. In general, the host system 520 can access multiple memory sub-systems via a same communication connection, multiple separate communication connections, and/or a combination of communication connections.

The memory devices 530A-530N can include any combination of the different types of non-volatile memory devices and/or volatile memory devices. In an illustrative example, one or more memory devices 530 may be represented by the compute device 102 or by the hybrid NVM/HBM devices 300A and/or 300B.

The volatile memory devices can be, e.g., random access memory (RAM), such as dynamic random access memory (DRAM) and synchronous dynamic random access memory (SDRAM). Some examples of non-volatile memory devices include negative-and (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

A memory device 530A-530N can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some implementations, each of the memory devices 530 can include one or more arrays of memory cells such as SLCs, MLCs, TLCs, QLCs, PLCs, or any combination of such. In some implementations, a particular memory device can include an SLC portion, and an MLC portion, a TLC portion, a QLC portion, or a PLC portion of memory cells. The memory cells of the memory devices 530A-530N can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory devices 530A-530N can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, electrically erasable programmable read-only memory (EEPROM).

A memory sub-system controller 515 can communicate with the memory device(s) 530 to perform operations such as reading data, writing data, or erasing data at the memory devices 530 and other such operations. The memory sub-system controller 515 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 515 can be a microcontroller, special purpose logic circuitry (e.g., a field programmable gate array (FPGA), an application specific integrated circuit (ASIC), etc.), or other suitable processor.

The memory sub-system controller 515 can include a processor 517 (e.g., a processing device) configured to execute instructions stored in a local memory 519. In the illustrated example, the local memory 519 of the memory sub-system controller 515 includes an embedded memory configured to store instructions for performing various processes, operations, logic flows, and routines that control operation of the memory sub-system 510, including handling communications between the memory sub-system 510 and the host system 520.

In some implementations, the local memory 519 can include memory registers storing memory pointers, fetched data, etc. The local memory 519 can also include read-only memory (ROM) for storing micro-code. While the example memory sub-system 510 in FIG. 5 has been illustrated as including the memory sub-system controller 515, in another implementation of the present disclosure, a memory sub-system 510 does not include a memory sub-system controller 515, and can instead rely upon external control (e.g., provided by an external host, or by a processor or controller separate from the memory sub-system).

In general, the memory sub-system controller 515 can receive commands or operations from the host system 520 and can convert the commands or operations into instructions or appropriate commands to achieve the desired access to the memory device(s) 530. The memory sub-system controller 515 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory device(s) 530. The memory subsystem controller 515 can further include host interface circuitry to communicate with the host system 520 via the physical host interface. The host interface circuitry can convert the commands received from the host system into command instructions to access the memory device(s) 530 as well as convert responses associated with the memory device(s) 530 into information for the host system 520.

The memory sub-system 510 can also include additional circuitry or components that are not illustrated. In some implementations, the memory sub-system 510 can include a cache or buffer (e.g., DRAM) and address circuitry (e.g., a row decoder and a column decoder) that can receive an address from the memory sub-system controller 515 and decode the address to access the memory device(s) 530.

In some implementations, the memory device(s) 530 include local media controllers 535 that operate in conjunction with memory sub-system controller 515 to execute operations on one or more memory cells of the memory device(s) 530. An external controller (e.g., memory sub-system controller 515) can externally manage the memory device 530 (e.g., perform media management operations on the memory device(s) 530). In some implementations, a memory device 530 is a managed memory device, which is a raw memory device (e.g., memory array 304) having control logic (e.g., local controller 535) for media management within the same memory device package. An example of a managed memory device is a managed NAND (MNAND) device. Memory device(s) 530, for example, can each represent a single die having some control logic (e.g., local media controller 535) embodied thereon. In some implementations, the local media controller 535 may be represented by the controller 122 of FIG. 1 or the controller 322 of FIGS. 3A-3B.

In some implementations, the memory sub-system 510 includes a memory interface 513 that is responsible for handling interactions of memory sub-system controller 515 with the memory devices of memory sub-system 510, such as memory devices 530A-530N. For example, the memory interface 513 can send or transmit memory access commands corresponding to requests received from host system 520 to memory devices 530A-530N, such as program commands, read commands, or other commands. In addition, the memory interface 513 can receive data from devices 530A-530N, such as data retrieved in response to a read command or a confirmation that a program command was successfully performed. In some implementations, the memory sub-system controller 515 includes at least a portion of the memory interface 513. For example, the memory sub-system controller 515 can include a processor 517 (processing device) configured to execute instructions stored in local memory 519 for performing the operations described herein.

In some implementations, the host system 520 implements an ML/AI framework 550. ML/AI framework 550 can include one or more ML models, a processing engine, and a training engine, among other components, which can be used to perform any automated task (e.g., classify or categorize documents or images). In order to train the one or more ML models, ML/AI framework 550 can issue requests to read the training data, which may be stored on one or more memory devices 530A-530N, and process the training data accordingly. In some implementations, ML/AI framework 550 is executed by multiple processing units (e.g., GPUs and/or CPUs) which can process many threads/streams in parallel.

In some implementations, host system 520 could include hundreds of parallel processing threads that can request and process different subsets of the training data concurrently. In some implementations, at least some of the processing tasks of the ML/AI framework 550 are performed by the compute die 110 of the compute device 102 (FIG. 1) or by the processing units 312, 314 residing on the hybrid memory device 300A of FIG. 3A. In embodiments, one or more of the compute device 102 or the hybrid memory devices 300A are employed by the memory sub-system as memory devices 530A-530N.

Once a certain amount of training is complete, ML/AI framework 550 can enter an inference phase to analyze different input data. The input data can similarly be stored on memory device 530 of the same or a different memory sub-system 510. In some implementations, ML/AI framework 550 can issue requests to read the input data from memory sub-system 510 and store a copy of the input data in the host memory 522.

In some implementations, the host system 520 utilizes a set of queues to track the memory access commands issued to the memory sub-system 510 (e.g., requests to read data for ML/AI framework 550). For example, the host system 520 can include a number of submission queues, storing submission queue entries representing the memory access commands issued to the memory sub-system 510, and a number of completion queues, storing completion queue entries received from the memory sub-system 510 to indicate that the corresponding memory access commands have been executed. In some implementations, the host system 520 can maintain these queues in the host memory 522.

The host memory 522 may include one or more DRAM devices, HBM devices, and/or other types of memory devices. In some implementations, the host memory 522 includes the compute device 102 or one of the hybrid HBM/NVM memory devices 300A and/or 300B of FIGS. 3A-3B.

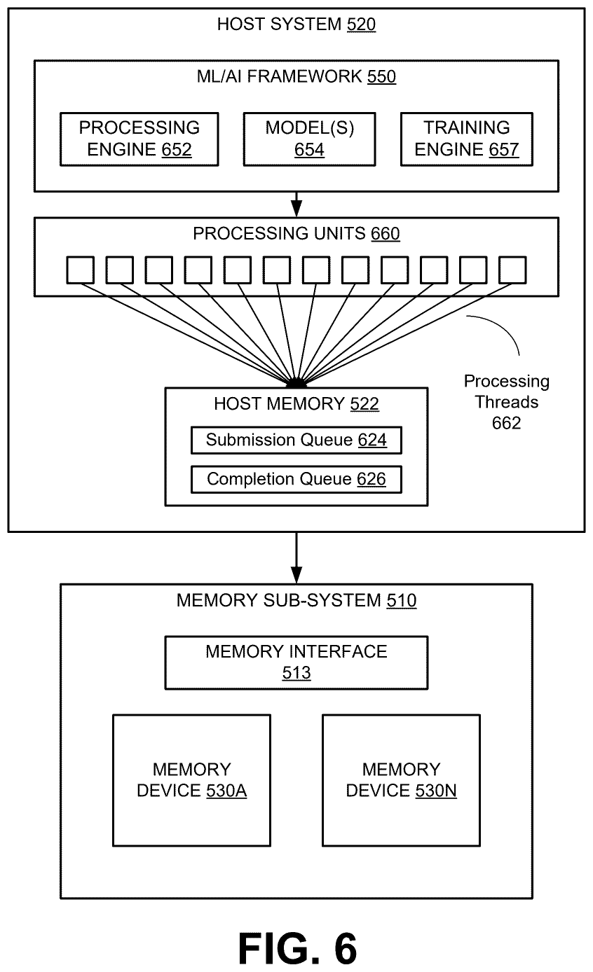

FIG. 6 is a block diagram illustrating a system for performing AI model inference operations using memory devices and/or host systems implemented in accordance with aspects of the present disclosure. As illustrated, host system 520 includes ML/AI framework 550 which can be executed by a number of processing threads 662. Host system 520 further includes host memory 522, including submission queues 624 and completion queues 246. In some implementations, ML/AI framework 550 includes a processing engine 652, one or more machine learning models 654, and a training engine 656, among other components, which can be used to perform any automated task (e.g., classify or categorize documents or images). Depending on the implementation one or more components that make up ML/AI framework 550 can be distributed across multiple different computing devices (e.g., host computers, servers, etc.). In some implementations, processing engine 652 may use a set of trained machine learning models 654 that are trained and used to perform any number of automated operations. The processing engine 652 may also preprocess any received input data prior to using the data for training of the set of machine learning models 654 and/or applying the set of trained machine learning models 654 to the input data. Based on the output of the set of trained machine learning models 654, the processing engine 652 may obtain, for example, a classification and/or category of the input data, as well an assessment of the classification.

In some implementations, at least some of the processing tasks of the ML/AI framework 550 are performed by the compute die 110 residing on the compute device 102 of FIG. 1 or by processing units 312, 314 residing on the compute die 310 of a hybrid memory device 300A of FIG. 3A. In embodiments, the compute device 102A or one or more hybrid memory devices 300A are employed by the memory sub-system as memory devices 530A-530N.

The set of machine learning models 674 may refer to model artifacts that are created by the training engine 656 using training data that includes training inputs and corresponding target outputs (i.e., correct answers for respective training inputs). During training, patterns in the training data that map the training input to the target output (i.e., the answer to be predicted) can be found, and are subsequently used by the machine learning models 654 for future predictions. Depending on the implementation, the set of machine learning models 654 may be composed of, for example, a single level of linear or non-linear operations (e.g., a support vector machine [SVM]) or may be a deep network, (i.e., a machine learning model that is composed of multiple levels of non-linear operations). Examples of deep networks are neural networks including convolutional neural networks, recurrent neural networks with one or more hidden layers, and fully connected neural networks.

Thus, in order to train and utilize the one or more machine learning models 654, ML/AI framework 550 can issue requests to read training data and input data, which may be stored on memory device 530 of memory sub-system 510, and process the data accordingly. In some implementations, these memory access requests are sent by the parallel processing threads 662 being executed by respective processing units 660. The processing units 660 can include a number of general-purpose processing devices such as microprocessors, central processing units (CPUs), or the like, or more specialized processing devices, such as graphics processing units (GPUs), which may be optimized for performing high-speed sequential processing operations. Thus, at least some of the processing units 660 may be the compute device 102 of FIG. 1.

Depending on the implementation there can be any number of processing units 660 (e.g., tens or hundreds), each executing a respective one or more of the processing threads 662. Each processing thread 662 represents a series of sequential operations directed to memory subsystem 510 (e.g., read requests for separate segments of an element of training or input data stored at memory sub-system 510). Due to the large relative size of the training data or input data, each element may be broken up into separate segments of a smaller fixed size and stored at sequential memory addresses in memory sub-system 510. Thus, in order to read the entire element of data, a sequence of multiple read requests can be issued to obtain all of the separate segments. Each processing thread 662 can include a series of read requests to read the segments of a different element of data from memory sub-system 510. Upon the read requests from each processing thread 662 being generated, the requests can be stored as entries in one of submission queues 624, from which they can be issued to memory sub-system 510. Received responses to the requests from memory sub-system 510 can be stored as entries in one of completion queues 646, retrieved by processing threads 662 and provided to ML/AI framework 550 for execution in either a training phase or an inference phase.

FIG. 7 illustrates an example machine of a computer system 700 within which a set of instructions, for causing the machine to perform any one or more of the methodologies discussed herein, can be executed. In some implementations, the computer system 700 can correspond to a host system (e.g., the host system 520 of FIG. 5) that includes, is coupled to, or utilizes a memory sub-system (e.g., the memory sub-system 510 of FIG. 5) or can be used to perform the operations of a controller (e.g., to execute an operating system to perform operations corresponding to the memory interface 513 or memory sub-system controller 518 of FIG. 5). In alternative implementations, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processing device 702, a main memory 704 (e.g., read-only memory (ROM), flash memory, dynamic random access memory (DRAM) such as synchronous DRAM (SDRAM) or Rambus DRAM (RDRAM), etc.), a static memory 706 (e.g., flash memory, static random access memory (SRAM), etc.), and a data storage system 718, which communicate with each other via a bus 730.

Processing device 702 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 702 can also be one or more special-purpose processing devices such as an application specific integrated circuit (ASIC), a field programmable gate array (FPGA), a digital signal processor (DSP), network processor, or the like. The processing device 702 is configured to execute instructions 728 for performing the operations and steps discussed herein. The computer system 700 can further include a network interface device 708 to communicate over the network 720.

The data storage system 718 can include a machine-readable storage medium 724 (also known as non-transitory computer-readable storage medium) on which is stored one or more sets of instructions 728 (executable instructions) or software embodying any one or more of the methodologies or functions described herein. The instructions 728 can also reside, completely or at least partially, within the main memory 704 and/or within the processing device 702 during execution thereof by the computer system 700, the main memory 704 and the processing device 702 also constituting machine-readable storage media. The machine-readable storage medium 724, data storage system 718, and/or main memory 704 can correspond to the memory sub-system 510 of FIG. 5. In some implementations, the data storage system 718 may include the compute device 102 or one or more hybrid HBM/NVM memory devices 300A and/or 300B of FIGS. 3A-3B.

In some implementations, the instructions 728 include instructions to implement functionality corresponding to the memory interface 513 of FIG. 5). While the machine-readable storage medium 724 is shown in an example implementation to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some implementations, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, implementations of the disclosure have been described with reference to specific example implementations thereof. It will be evident that various modifications can be made thereto without departing from the broader spirit and scope of implementations of the disclosure as set forth in the following claims. The specification and drawings are, accordingly, to be regarded in an illustrative sense rather than a restrictive sense.

What is claimed is:

1. A compute device comprising:
a compute die disposed on a package substrate;
an on-chip cache disposed on the package substrate and coupled to the compute die, wherein the on-chip cache comprises one or more volatile memory dies and one or more non-volatile memory dies; and
a memory controller, disposed on the package substrate, and coupled between the compute die and the on-chip cache, wherein the memory controller is configured to perform operations comprising:
determining a first memory size requirement of one or more first operations executed by the compute die;
determining that the first memory size requirement satisfies a threshold criterion; and
responsive to determining that the first memory size requirement satisfies the threshold criterion, disabling the one or more non-volatile memory dies in the on-chip cache.

2. The compute device of claim 1, wherein the one or more first operations comprise at least one of training or executing at least one of a machine learning (ML) model or artificial intelligence (AI) model.

3. The compute device of claim 1, wherein determining the first memory size requirement of the one or more first operations executed by the compute die comprises receiving an indication of the first memory size requirement from the compute die.

4. The compute device of claim 1, wherein determining the first memory size requirement of the one or more first operations executed by the compute die comprises:
monitoring one or more operational parameters of the non-volatile memory dies to determine a bandwidth associated with the non-volatile memory dies; and
determining a saturation level of the volatile memory dies.

5. The compute device of claim 4, wherein determining that the first memory size requirement satisfies the threshold criterion comprises determining that the first memory size requirement is less than a predefined threshold amount, and wherein the predefined threshold amount is based on the bandwidth associated with the one or more non-volatile memory dies.

6. The compute device of claim 1, wherein the memory controller is configured to perform operations further comprising:
determining a second memory size requirement of one or more second operations executed by the compute die;
determining that the second memory size requirement does not satisfy the threshold criterion; and
responsive to determining that the second memory size requirement does not satisfy the threshold criterion, re-enabling the one or more non-volatile memory dies in the on-chip cache.

7. The compute device of claim 1, wherein the one or more volatile memory dies comprise high-bandwidth memory (HBM) dies.

8. The compute device of claim 1, wherein the one or more non-volatile memory dies comprise negative-and (NAND) type flash memory dies.

9. The compute device of claim 1, further comprising:
a logic die, disposed on the package substrate, the logic die comprising the memory controller;
an interposer interconnecting the compute die and logic die; and
an interconnect coupled to an off-chip cache that is located off of the package substrate.

10. A method comprising:
determining a first memory size requirement of one or more first operations executed by a compute die disposed on a package substrate in a compute device, the compute device comprising an on-chip cache disposed on the package substrate and coupled to the compute die, wherein the on-chip cache comprises one or more volatile memory dies and one or more non-volatile memory dies;
determining that the first memory size requirement satisfies a threshold criterion; and
responsive to determining that the first memory size requirement satisfies the threshold criterion, disabling the one or more non-volatile memory dies in the on-chip cache.

11. The method of claim 10, wherein the one or more first operations comprise at least one of training or executing at least one of a machine learning (ML) model or artificial intelligence (AI) model.

12. The method of claim 10, wherein determining the first memory size requirement of the one or more first operations executed by the compute die comprises receiving an indication of the first memory size requirement from the compute die.

13. The method of claim 10, wherein determining the first memory size requirement of the one or more first operations executed by the compute die comprises:
monitoring one or more operational parameters of the non-volatile memory dies to determine a bandwidth associated with the non-volatile memory dies; and
determining a saturation level of the volatile memory dies.

14. The method of claim 13, wherein determining that the first memory size requirement satisfies the threshold criterion comprises determining that the first memory size requirement is less than a predefined threshold amount, and wherein the predefined threshold amount is based on the bandwidth associated with the one or more non-volatile memory dies.

15. The method of claim 10, further comprising:
determining a second memory size requirement of one or more second operations executed by the compute die;
determining that the second memory size requirement does not satisfy the threshold criterion; and
responsive to determining that the second memory size requirement does not satisfy the threshold criterion, re-enabling the one or more non-volatile memory dies in the on-chip cache.

16. The method of claim 10, wherein the one or more volatile memory dies comprise high-bandwidth memory (HBM) dies.

17. The method of claim 10, wherein the one or more non-volatile memory dies comprise negative-and (NAND) type flash memory dies.

18. A non-transitory computer-readable storage medium storing instructions that, when executed by a processing device, cause the processing device to perform operations comprising:
determining a first memory size requirement of one or more first operations executed by a compute die disposed on a package substrate in a compute device, the compute device comprising an on-chip cache disposed on the package substrate and coupled to the compute die, wherein the on-chip cache comprises one or more volatile memory dies and one or more non-volatile memory dies;
determining that the first memory size requirement satisfies a threshold criterion; and
responsive to determining that the first memory size requirement satisfies the threshold criterion, disabling the one or more non-volatile memory dies in the on-chip cache.

19. The non-transitory computer-readable storage medium of claim 18, wherein the one or more first operations comprise at least one of training or executing at least one of a machine learning (ML) model or artificial intelligence (AI) model.

20. The non-transitory computer-readable storage medium of claim 18, wherein the one or more volatile memory dies comprise high-bandwidth memory (HBM) dies, and wherein the one or more non-volatile memory dies comprise negative-and (NAND) type flash memory dies.
